(19) United States
(12) Patent Application Publication
(10) Pub. No.: US 2017/0323267 A1
(43) Pub. Date: Nov. 9, 2017

(54) SYSTEM AND METHOD FOR PROVIDING WORK ALLOCATION AND COLLABORATION

(71) Applicant: NHN Entertainment Corporation, Seongnam-si (KR)

(72) Inventors: Changyol BAEK, Seongnam-si (KR); KyoungHwan LEE, Seongnam-si (KR)

(21) Appl. No.: 15/581,535

(22) Filed: Apr. 28, 2017

(30) Foreign Application Priority Data
May 4, 2016 (KR) 10-2016-0055498

(51) Int. Cl. G06Q 10/10; G06Q 10/06

(52) U.S. Cl. CPC G06Q 10/103; G06Q 10/063114; G06Q 10/107

(57) ABSTRACT

A task tracking method includes recognizing, through a message communication tool, and tracking, as a task, a message that includes project information associated with a project or complete date information of a task associated with the project; identifying a member and a non-member of the task in response to tracking the task; and assigning the task associated with the project to the non-member through the message communication tool and granting a right to use the task so that collaboration is performed between the member and the non-member perform.

### CROSS-REFERENCE TO RELATED APPLICATION

This application claims priority from and the benefit of Korean Patent Application No. 10-2016-0055498, filed on May 4, 2016, which is hereby incorporated by reference for all purposes as if fully set forth herein.

### BACKGROUND

### Field

Exemplary embodiments relate to a method and system for assigning a work and providing collaboration.

### Discussion of the Background

Business process management relates to separating a business process from an application program and systematically managing the is business process, and defines, executes, analyzes, and automates the business process. A business process management system (BPMS) to perform such business process management may define and model businesses, for example, work, which are repeatedly performed, and may support a systematic management and operation of relevant documents, information, tasks, etc., while executing a modeled business.

In the recent times, with the increasing interchangeability of business processes among companies, it is necessary to consider not only internal activities but also businesses performed in connection with other companies. Accordingly, there is a need for technology that may provide an integrated work management through interworking between work associated with a business and may establish a disclosure scope of the business based on the right of each user and thereby enable collaboration.

### SUMMARY

Exemplary embodiments provide a task tracking method and system that may recognize, through a message communication tool, and track, as a task, a message that includes project information associated with a project or complete date information of a task associated with the project, may identify a member and a non-member of the task in response to tracking the task, and may assign the task associated with the project to the non-member through the message communication tool and granting a right to use the task so that collaboration is performed between the member and the non-member.

Additional features of the exemplary embodiments of the inventive concepts will be set forth in the description which follows, and in part will be apparent from the description, or may be learned by practice of the exemplary embodiments of the inventive concepts.

Exemplary embodiments disclose a task tracking method including recognizing, through a message communication tool, and tracking, as a task, a message that includes project information associated with a project or complete date information of a task associated with the project; identifying a member and a non-member of the task in response to tracking the task; and assigning the task associated with the project to the non-member through the message communication tool and granting a right to use the task so that collaboration is performed between the member and the non-member.

The assigning and the granting may include granting the non-member a right to use a specific task associated with the project in response to a preset tag being assigned to a name of the non-member.

The assigning and the granting may include displaying the specific task assigned to the non-member through the message communication tool.

The assigning and the granting may include transferring the project or the task associated with the project, by email of the user, to a user that does not use the message communication tool.

The assigning and the granting may include indicating that a reply is to be automatically added as a comment to a main text of the project or the task associated with the project in response to the reply received from the user that does not use the message communication tool to the project or the task associated with the project that is transferred to the user by e-mail.

The assigning and the granting may include providing an interface of managing a mail using the task, and switching the mail to the task in response to an instruction input through the interface.

The assigning and the granting may include displaying a message indicating that the mail is switched to the project or the task associated with the project in response to the mail being switched to the task.

Exemplary embodiments also provide a non-transitory computer-readable medium storing a computer program to implement a task tracking method including recognizing, through a message communication tool, and tracking, as a task, a message that includes project information associated with a project or complete date information of a task associated with the project; identifying a member and a non-member of the task in response to tracking the task; and assigning the task associated with the project to the non-member through the message communication tool and granting a right to use the task so that collaboration is performed between the member and the non-member.

Exemplary embodiments also provide a task tracking system including a processor configured with processor-executable instructions to: recognize, through message communication tool, and track, as a task, a message that includes project information associated with a project or complete date information of a task associated with the project (i.e., a tracker); identify a member and a non-member of the task in response to tracking the task (i.e., an identifier); and assign the task associated with the project to the non-member through the message communication tool and grant a right to use the task so that collaboration is performed between the member and the non-member (i.e., a provider).

The provider may be configured to grant the non-member a right to use a specific task associated with the project in response to a preset tag being assigned to a name of the non-member.

The provider may be configured to display the specific task assigned to the non-member through the message communication tool.

The provider may be configured to transfer, by email of the user, the project or the task associated with the project to a user that does not use the message communication tool.

The provider may be configured to indicate that a reply is to be automatically added as a comment to a main text of the project or the task associated with the project in response to the reply received from the user that does not use the message communication tool to the project or the task associated with the project that is transferred to the user by e-mail.

The provider may be configured to provide an interface of managing a mail using the task, and switching the mail to the task in response to an instruction input through the interface.

The provider may be configured to display a message indicating that the mail is switched to the project or the task associated with the project in response to the mail being switched to the task.

According to exemplary embodiments, a task tracking system may grant a non-member of a project or a task a right to use a task through a message communication tool so that collaboration may be performed between a member and the non-member.

Also, according to exemplary embodiments, a task tracking system may grant a non-member a right to use a portion of tasks associated with a project so that the confidential of the entire project ongoing at a company may be maintained.

It is to be understood that both the foregoing general description and the following detailed description are exemplary and explanatory and are intended to provide further explanation of the exemplary embodiments of the inventive concepts as claimed.

### BRIEF DESCRIPTION OF THE DRAWINGS

The accompanying drawings, which are included to provide a further understanding of the exemplary embodiments of the inventive concepts and are incorporated in and constitute a part of this specification, illustrate embodiments of the inventive concepts, and together with the description serve to explain the principles of the exemplary embodiments of the inventive concepts.

FIG. 1 illustrates an example of a user terminal and a server according to exemplary embodiments.

FIG. 2 illustrates an example of components of a task tracking system according to exemplary embodiments.

FIG. 3 is a flowchart illustrating an example of a task tracking method performed at a task tracking system according to exemplary embodiments.

FIG. 4 illustrates an example of identifying a member and a non-member of a project or a task at a task tracking system according to exemplary embodiments.

FIG. 5 illustrates an example of not granting a non-member of a task a right to use the task at a task tracking system according to exemplary embodiments.

FIG. 6 illustrates an example of assigning a task at a task tracking system according to exemplary embodiments.

FIG. 7 illustrates an example of granting a non-member of a task a right to use the task at a task tracking system according to exemplary embodiments.

FIG. 8 illustrates an example of adding reply content to a task in response to transferring the task to a user by email at a task tracking system according to exemplary embodiments.

FIG. 9 illustrates an example of managing a mail as a task at a task tracking system according to exemplary embodiments.

### DETAILED DESCRIPTION OF THE ILLUSTRATED EMBODIMENTS

Exemplary embodiments will be described in detail with reference to the accompanying drawings. These exemplary embodiments will be described in detail for those skilled in the art in order to practice the present disclosure. It should be appreciated that various exemplary embodiments are different but do not have to be exclusive. For example, specific shapes, configurations, and characteristics described in an exemplary embodiment may be implemented in another exemplary embodiment without departing from the spirit and the scope of the present disclosure. In addition, it should be understood that position and arrangement of individual components in each disclosed exemplary embodiment may be changed without departing from the spirit and the scope of the present disclosure. Therefore, a detailed description described below should not be construed as being restrictive. In addition, the scope of the present disclosure is defined only by the accompanying claims and their equivalents if appropriate. Similar reference numerals will be used to describe the same or similar functions throughout the accompanying drawings. It will be understood that for the purpose of this disclosure, “at least one of X, Y, and Z” can be construed as X only, Y only, Z only, or any combination of two or more items X, Y, and Z (e.g., XYZ, XYY, YZ, ZZ).

The terminology used herein is for the purpose of describing exemplary embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising”, “includes” and/or “including” when used in this specification, specify the presence of stated features, integers, steps, operations, elements and/or components, but do not preclude the presence or addition of one or more other features, integers, steps, operations, elements, components, and/or groups thereof.

Hereinafter, exemplary embodiments are described in detail with reference to the accompanying drawings.

It will be understood that when an element is referred to as being “connected to” another element, it can be directly connected to the other element, or intervening elements may be present.

Also, the term “mail” used herein refers to an email transmitted and/or received over the Internet and thus, the terms “mail” and “email” are interchangeably used.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Hereinafter, exemplary embodiments will be described with reference to the accompanying drawings.

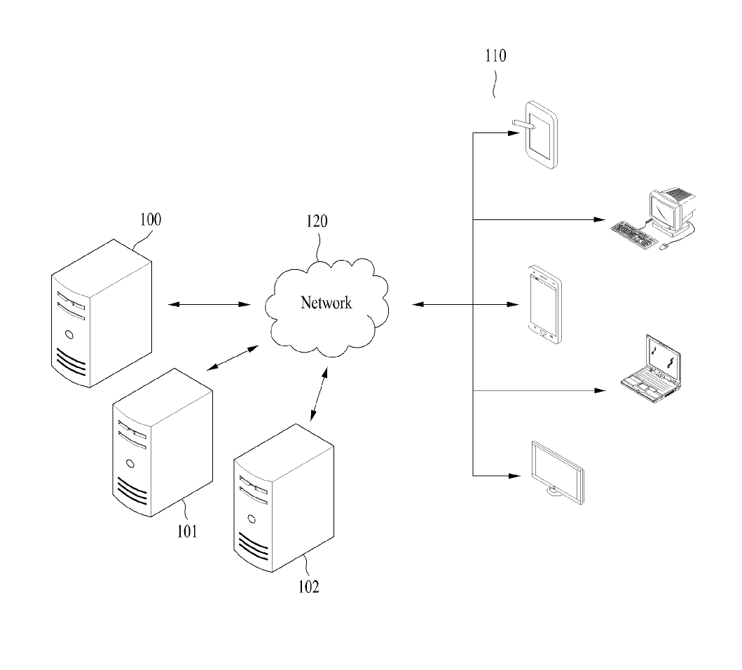

FIG. 1 is a diagram illustrating an example of a network environment according to at least one exemplary embodiment. Referring to FIG. 1, the network environment includes a user terminal 110, a plurality of servers 100, 101, and 102, and a network 120. FIG. 1 is provided as an example only and thus, the number of user terminals and/or the number of servers are not limited thereto.

The user terminal 110 may be a fixed terminal or a mobile terminal configured as a computer device. For example, the user terminal 110 may be a smartphone, a mobile phone, navigation, a computer, a laptop computer, a digital broadcasting terminal, a personal digital assistant (PDA), a portable multimedia player (PMP), a tablet personal computer (PC), and the like. For example, the user terminal 110 may communicate with other user terminals and/or the servers 100, 101, and/or 102 over the network 120 in a wired communication manner or in a wireless communication manner.

The communication scheme is not particularly limited and may include a communication method that uses a near field communication between devices as well as a communication method using a communication network, for example, a mobile communication network, the wired Internet, the wireless Internet, and a broadcasting network, which may be included in the network 120. For example, the network 120 may include at least one of network topologies that include networks, for example, a personal area network (PAN), a local area network (LAN), a campus area network (CAN), a metropolitan area network (MAN), a wide area network (WAN), a broadband network (BBN), the Internet, and the like. Also, the network 120 may include at least one of network topologies that include a bus network, a star network, a ring network, a mesh network, a star-bus network, a tree or hierarchical network, and the like. However, it is only an example and the exemplary embodiments are not limited thereto.

Each of the servers 100, 101, and 102 may be configured as a computer apparatus or a plurality of computer apparatuses that include processors and provide instructions, codes, files, contents, services, and the like through communication with the user terminal 110 over the network 120.

For example, the server 100 may provide a file for installing an application to the user terminal 110 over the network 120. In this case, the user terminal 110 may install the application using the file provided from the server 100. Also, the user terminal 110 may connect to the server 100 and may receive a service or content provided from the server 100 under control of at least one program (for example, a browser or the installed application) and an operating system (OS) included in the user terminal 110. For example, in response to a service request message transmitted from the user terminal 110 to the server 100 over the network 120 under control of the application, the server 100 may transmit a code corresponding to the service request message to the user terminal 110 and the user terminal 110 may configure and display a screen corresponding to the code under control of the application, thereby providing the content to a user.

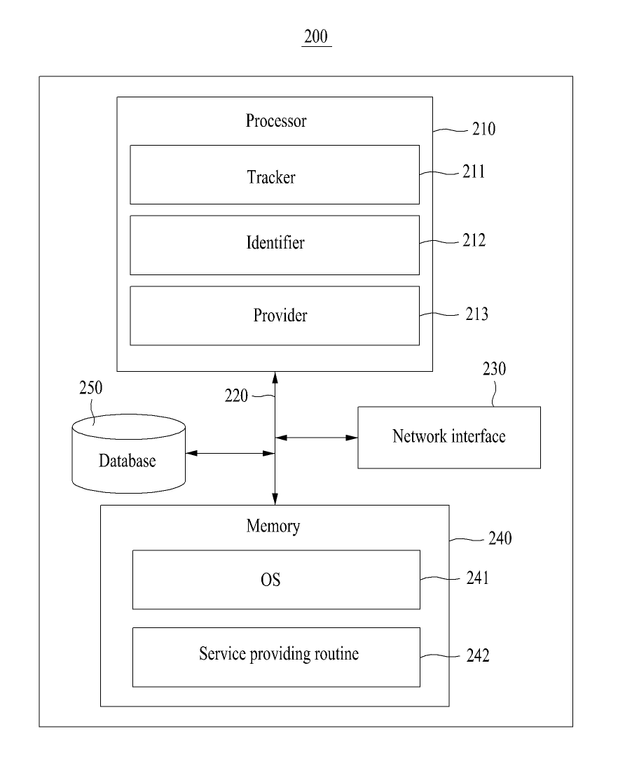

FIG. 2 is a block diagram illustrating an example of a configuration of a user terminal and a server according to at least one exemplary embodiment.

Referring to FIG. 2, a task tracking system 200 may include a processor 210, a bus 220, a network interface 230, a memory 240, and a database 250. The memory 240 may include an OS 241 and a service providing routine 242. The processor 210 may include a tracker 211, an identifier 212, and a provider 213. According to other exemplary embodiments, the task tracking system 200 may include a greater or lesser number of components that the number of components shown in FIG. 2. However, there is no need to clearly illustrate many components according to the related art. For example, the task tracking system 200 may include other components, such as a display or a transceiver.

The memory 240 may include a permanent mass storage device, such as random access memory (RAM), read only memory (ROM), and a disk drive, as a non-transitory computer-readable recording medium. Also, a program code for the OS 241 and the service providing routine 242 may be stored on the memory 240. Software components may be loaded to the memory 240 through another computer-readable recording medium separate from the memory 240 using a drive mechanism (not shown). The other computer-readable recording medium may include, for example, a floppy drive, a disk, a tape, a DVD/CD-ROM drive, a memory card, a flash drive, and the like. According to other exemplary embodiments, software components may be loaded to the memory 240 through the network interface 230 instead of, or in addition to, the computer-readable recording medium.

The bus 220 enables communication and data transmission between the components of the task tracking system 200. The bus 220 may be configured using a high-speed serial bus, a parallel bus, a storage area network (SAN) and/or other appropriate communication technologies.

The network interface 230 may be a computer hardware component for connecting the task tracking system 200 to a computer network. The network interface 230 may be, for example, a network interface card, such as an Ethernet card, an optical transceiver, a radio frequency (RF) transceiver, or any type of devices capable of transmitting and receiving information. As another example, the network interface 230 may be a wireless device that includes a mobile computing device, Bluetooth® in a universal serial bus (USB), 3^{rd}, 4^{th}, or 5^{th} Generation (3G, 4G, 5G), wireless fidelity (WiFi), long term evolution (LTE), and the like. Here, a computing device may use the network interface 230 for wireless communication with an external device, such as another networked computing device, a server, or a mobile phone. The network interface 230 may connect the task tracking system 200 to a computer network through a wireless connection or a wired connection.

The database 250 may serve to store and maintain any type of information required to manage information about a project or a task associated with the project. Although FIG. 2 illustrates that the database 250 is constructed in the task tracking system 200, it is provided as an example only. The entire database or a portion of the database may be present as an external database constructed on a separate system depending on a service configuration scheme or an environment, etc.

The processor 210 and the components of the processor 210 may be configured to execute computer-readable instructions corresponding to a code of at least one program and a code of the OS included in the memory 240. The computer-readable instructions may be provided from the memory 240 or the network interface 230 to the processor 210 through the bus 220. The processor 210 may be configured to execute program codes for the tracker 211, the identifier 212, and the provider 213. The program codes may be stored on a storage device such as the memory 240.

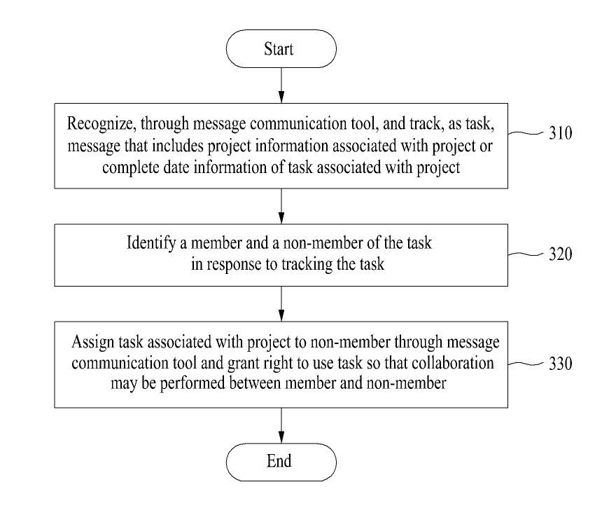

The task tracking system 200 and the components of the processor 210 may control the task tracking system 200 to perform operations 310 through 330 included in a task tracking method of FIG. 3. The processor 210 may load a program code for the tack tracking method to the memory 240.

Referring to FIG. 3, in operation 310, the tracker 211 may recognize, through a message communication tool, and track, as a task, a message that includes project information associated with a project or complete date information of a task associated with the project.

In operation 320, the identifier 212 may identify a member and a non-member of the task in response to tracking the task.

In operation 330, the provider 213 may assign the task associated with the project to the non-member through the message communication tool and may grant a right to use the task so that collaboration may be performed between the member and the non-member. The provider 213 may grant the non-member a right to use a specific task associated with the project in response to a preset tag being assigned to a name of the non-member. The provider 213 may display the specific task assigned to the non-member through the message communication tool.

The provider 213 may transfer the project or the task associated with the project, by email of the user, to a user that does not use the message communication tool. The provider 213 may indicate that a reply is to be automatically added as a comment to a main text of the project or the task associated with the project, in response to the reply received from the user that does not use the message communication tool to the project or the task associated with the project that is transferred to the user by e-mail.

The provider 213 may provide an interface of managing a mail using the task, and may switch the mail to the task in response to an instruction input through the interface. The provider 213 may display a message indicating that the mail is switched to the project or the task associated with the project in response to the mail being switched to the task.

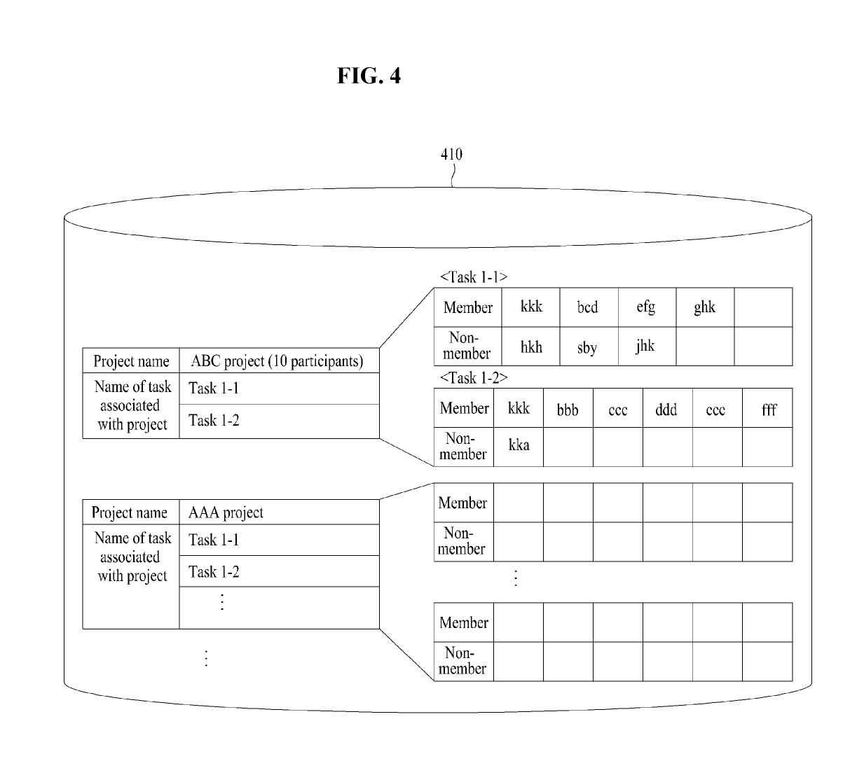

FIG. 4 illustrates an example of identifying a member and a non-member of a project or a task at a task tracking system according to exemplary embodiments.

Referring to FIG. 4, the task tracking system may store, in a database 410, information for identifying a member and a non-member of a project or a task, rights or permission information about the project or the task associated with the project, information indicating use or non-use of a message communication, and the like.

The task tracking system may store, in the database 410, a project name of the project, a name of the task associated with the project, the number of members participating in the project, and the like. Here, the task tracking system may store information about a member and a non-member participating in the project or the task.

The task tracking system may store information about a member and a non-member of each task, for example, a name, a team, a position, and a task participation term of each member and non-member, and the like. For example, when tasks associated with “ABC project” include task 1-1 and task 1-2, the task tracking system may store information about a member and a non-member associated with each task. The task tracking system may update information stored in the database 410 at preset time intervals.

Also, the task tracking system may assign a specific task to a non-member based on information stored in the database 410. The task tracking system may assign the specific task to the non-member such that the non-member is granted with a right to use the specific task. The non-member may be allowed to access only the assigned specific task.

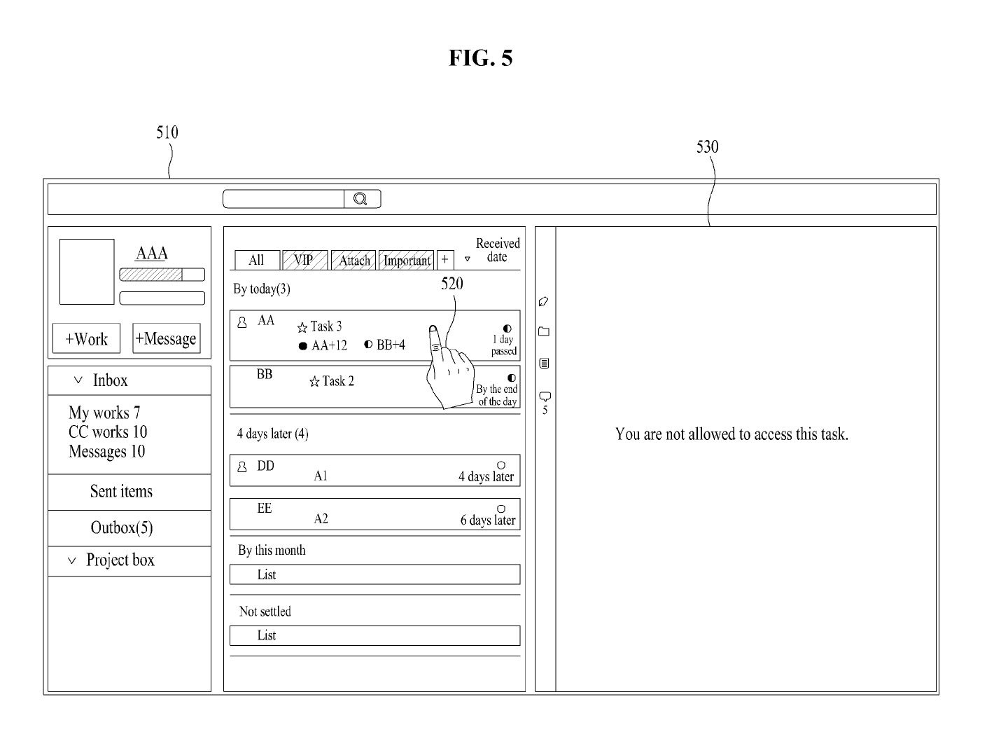

FIG. 5 illustrates an example of not granting a right to use a task to a non-member of that task at a task tracking system according to exemplary embodiments.

A message communication tool 510, as a tool for performing a collaborative process, may recognize a project and works, mails, messages, a schedule, a task tracker, a messenger, and documents associated with the project as a task and may enable interworking thereof to be integrally available. Also, the message communication tool 510 enables collaboration between members participating in each task and enables the members to share a progress state of a corresponding task in real time.

The task tracking system may recognize, through the message communication tool 510, and track, as a task, a message that includes project information associated with a project or complete date information of a task associated with the project. The task tracking system may display the project and the task associated with the project through the message communication tool 510. Here, the task tracking system may identify a member and a non-member of the task, and may set the range in which the identified member and non-member are allowed to access the project and the task associated with the project. For example, the task tracking system may grant the member a right to access the project and the task associated with the project and may not grant the non-member the right to access the project and the task associated with the project. The task tracking system may grant the non-member a non-access right with respect to the project and at least the rights to one of tasks associated with the project. That is, the task tracking system may grant the non-member participating in the project a right to access a portion of the tasks instead of granting a right to access the project and all of tasks. The non-member may be allowed to access and use only a task that the task tracking system grants the non-member the right to access.

For example, referring to FIG. 5, it is assumed that the message communication tool 510 is connected to an account of a user 520. The task tracking system may display a project and a task associated with the project through the message communication tool 510. Here, the user 520 may be a non-member or a member with respect to each project and each task associated with a corresponding project. The task tracking system may identify a non-member or a member of each task displayed on the message communication tool 510. In response to the user 520 selecting “Task 3”, the task tracking system may identify the user 520 as a member or a non-member in Task 3.

If the user 520 is a non-member of Task 3, the task tracking system may not disclose the main text of Task 3 to the user 520. The task tracking system may not display the main text of Task 3 and may display a message 530 indicating “You are not allowed to access this task” on the message communication tool 510. The task tracking system may display an interface of requesting a right to access a corresponding task together with the message 530 on the message communication tool 510. The user 520 may select the interface and may request the right to access the task.

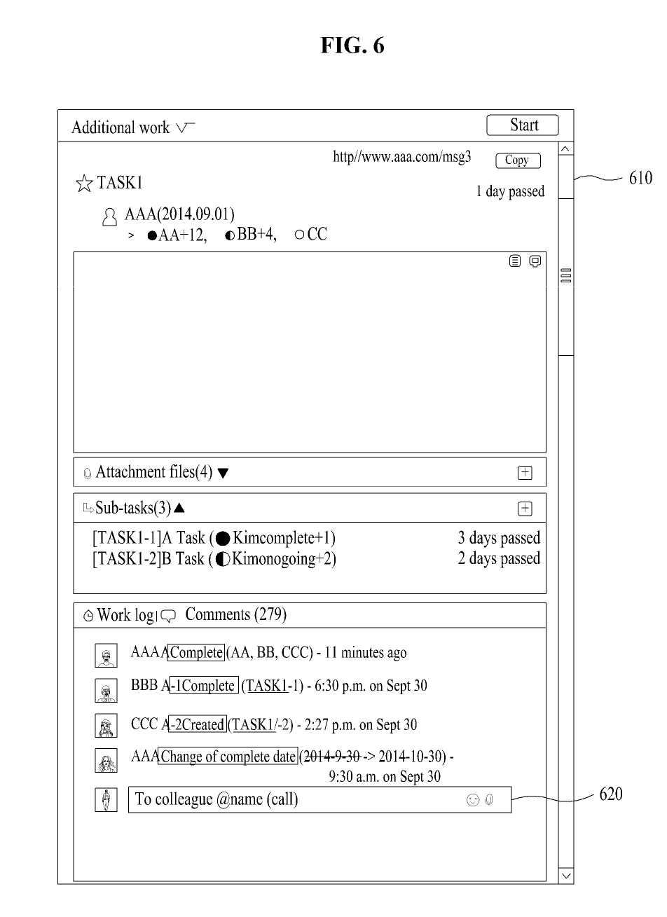

FIG. 6 illustrates an example of assigning a task at a task tracking system according to exemplary embodiments.

The task tracking system may assign a project and a task associated with the project to a non-member through a message communication tool. The task tracking system enables collaboration between the non-member and a member by assigning the task to the non-member and granting the non-member a right to use the task.

Referring to FIG. 6, the task tracking system may display a project and tasks associated with the project through the message communication tool. In response to a selection of the project and at least one of the tasks associated with the project displayed on the message communication tool, the task tracking system may display a main text 610 of a corresponding task. The task tracking system may grant a non-member of the task a right to use the task by assigning a preset tag to the non-member on a partial area 620 of the main text 610 displayed on the message communication tool. Here, the partial area 620 of the main text 610 may indicate a space in which members participating in the task share a progress state of the task, or for granting a right to access the task to the non-member who is not participating in the task.

For example, at least one of a project manager and members of a task may add a mention to a non-member to which the at least one of the project manager and the members desires to grant the right to access the task on the main text 610 of the task. In response to an input of “@non-member”, the task tracking system may grant a non-member who is mentioned in the input the right to access the task.

The preset tag for assigning the non-member the right to use the task is not limited to the users who are mentioned in the input. The task tracking system may change and set a symbol of a tag for assigning each right in accordance with a right of an administrator.

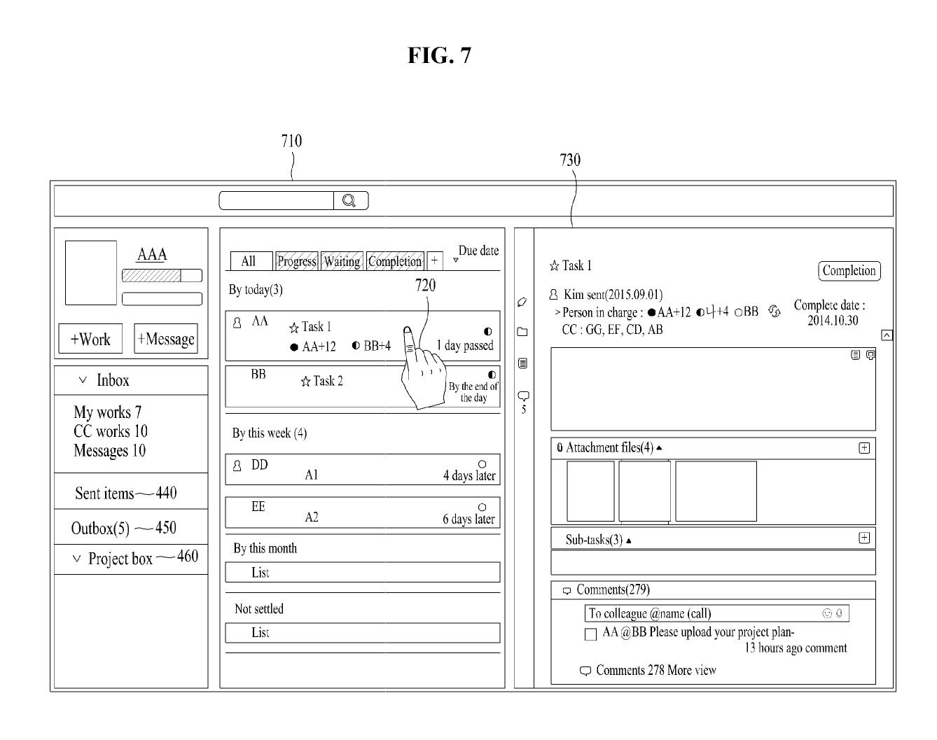

FIG. 7 illustrates an example of granting a non-member of a task a right to use the task at a task tracking system according to exemplary embodiments. The task tracking system may assign a non-member a right to use a specific task associated with a project in response to a preset tag being assigned to a name of the non-member.

Referring to FIG. 7, if the non-member is a user 720 using a message communication tool 710, the task tracking system may allow the non-member to view a main text 730 of a task of which the right to use is granted through the message communication tool 710. The task tracking system may display the task which the non-member is granted the right to use through the message communication tool 710. For example, the main text 730 of Task 1 may be displayed in response to the non-member selecting “Task 1” from a list of tasks displayed on the message communication tool 710. Here, detailed content of the task may be displayed on the main text 730. For example, the main text 730 may include a task progress state of each member participating in the task, sub-tasks associated with the task, and content of the task, and the like. The task tracking system may also grant the non-member, who has been granted with the right to access the task, a right to modify the main text 730 of the task. Through this, collaboration is enabled between the non-member and the member participating in the task.

If the non-member is a user who is not using the message communication tool 710, the task tracking system may provide information about the task that the non-member is granted the right to use by email of the non-member.

The task tracking system may assign a portion of tasks to the non-member instead of disclosing the entire project and may grant the non-member a right to use a specific task such that the non-member may only access the specific task. The task tracking system enables collaboration between the non-member and the member by granting the non-member the right to use the specific task.

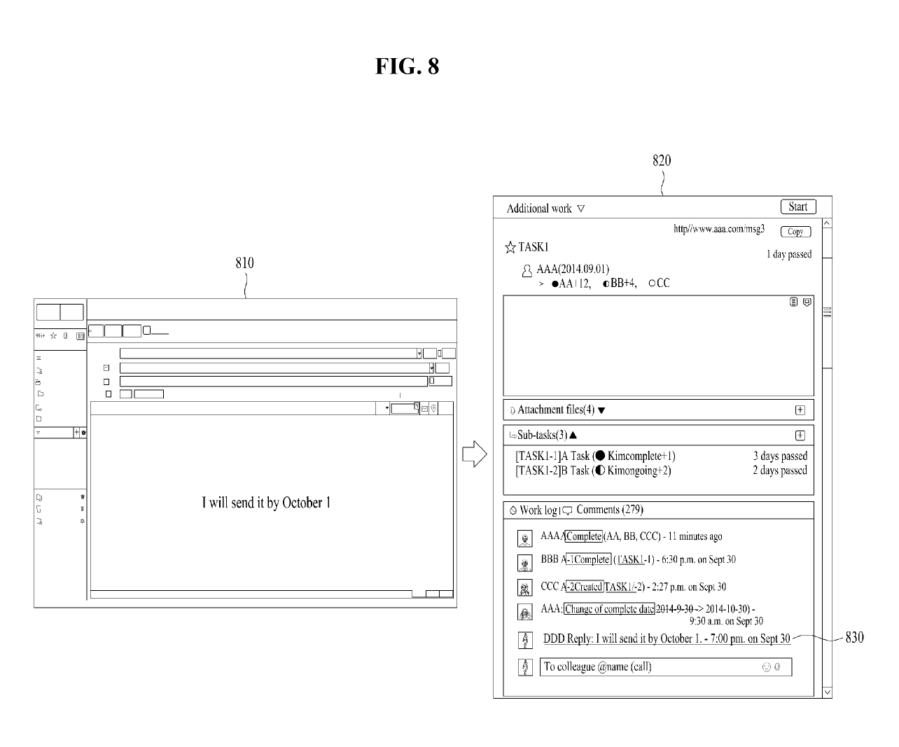

FIG. 8 illustrates an example of adding reply content to a task in response to transferring the task to a user by email at a task tracking system according to exemplary embodiments.

The task tracking system may transfer a project and a task associated with the project to a user not using a message communication tool by email. The task tracking system may transfer information, by email of the user, about the task, for example, a complete date of the task, work details the user is to implement in the task, a participant(s) of the task, and the like, to the user not using the message communication tool. Here, the task tracking system may provide a function of transmitting and receiving emails through the message communication tool.

The user not using the message communication tool may reply in response to receiving the project or the task associated with the project through a personal email 810 of the user. Here, content replied from the user may be automatically added, as a comment, to a main text 820 of the project or the task associated with the project displayed through the message communication tool. The task tracking system may indicate that the reply is automatically added as a comment 830 to the main text 820 of the project or the task associated with the project displayed through the message communication tool. For example, when it is assumed that the user not using the message communication tool is participating in the project or the task associated with the project, the user may make a reply mail to the project or the task associated with the project through an email account of the user. The user may reply by filling in the reply “I will send it by October 1.” The task tracking system may display, in the comment 830, the replied date together with a message “DDD reply: I will send it by October 1” on the main text 820 of the project or the task associated with the project.

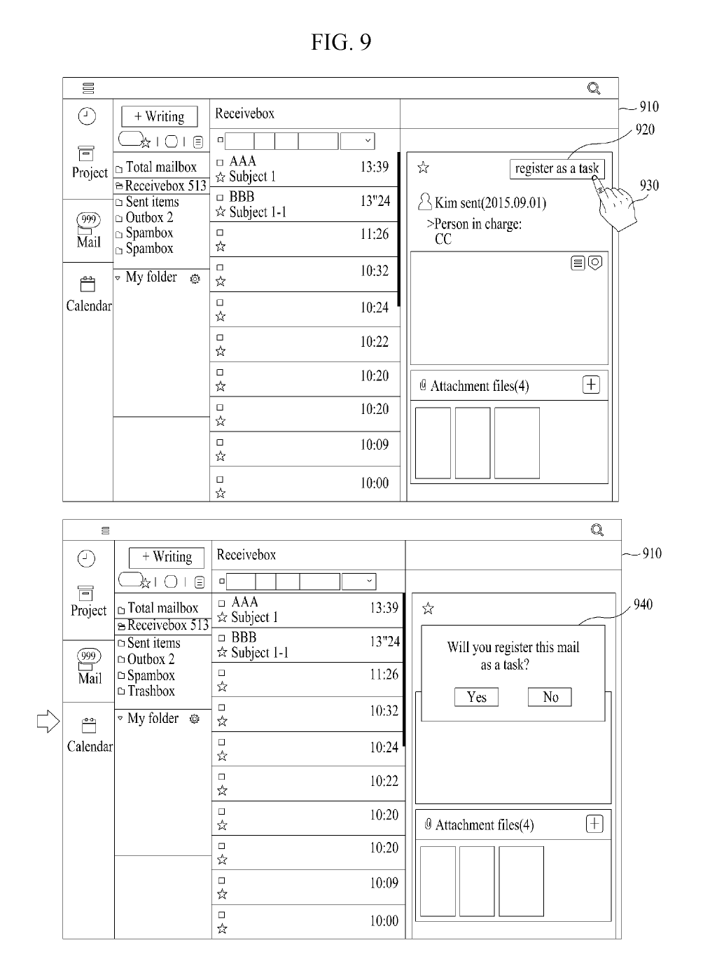

FIG. 9 illustrates an example of managing a mail using a task at a task tracking system according to exemplary embodiments.

The task tracking system may provide an interface 920 for managing a mail as a task through a message communication tool 910, and may switch the mail to the task in response to an instruction input through the interface 920. Here, the interface 920 may be displayed on an area in which mail content is filled and also may be separately displayed on a partial area of the message communication tool 910. For example, the task tracking system may provide an interface “register as a task” for registering a mail displayed on the message communication tool 910 as a task. A user 930 may select the interface “register as a task” for registering a mail as a task. The task tracking system may display a message 940 indicating “Will you register this mail as a task?” and may inquire the user 930 about whether the user 930 agrees through the interface selected by the user 930. The user 930 may select “yes” if the user 930 desires to register the mail as the task, and may select “no” if the user 930 does not desire to register the mail as the task.

The task tracking system may search for a task associated with the mail in response to receiving an input from the user 930 for registering the selected mail as the task. For example, the task tracking system may track a task associated with the mail selected by the user 930 based on a title, content, a sender, carbon copy (CC), etc., of the selected mail. The task tracking system may track the mail associated with the mail and may include the mail in the task. Alternatively, if the task associated with the mail is absent, the task tracking system may generate and register a new project or a new task. Alternatively, the task tracking system may provide an interface for including the mail selected by the user 930 in a project or a task desired by the user 930. The task tracking system may include the mail in the project or the task designated by the user 930.

The task tracking system may transmit a message indicating that the mail is moved to the task or registered as the task through the message communication tool 910. For example, the task tracking system may display a message indicating “This mail is moved to Task 1” through the message communication tool 910 of the user 930.

The task tracking system may add, as a comment, content that a mail is moved to a task to a main text corresponding to the project or the task the mail is moved to. The task tracking system may display the added comment on the main text of the project or the task associated with the project displayed on the message communication tool 910. For example, the task tracking system may automatically add and display a comment, such as “Mail A is moved to the task” in the main text of the project or the task displayed on the message communication tool 910.

Accordingly, members participating in the project or the task may recognize the added mail as the task. Subsequently, the task tracking system may distribute a work included in the mail to the members such that each of the members may share a progress state of the distributed work with other members.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The exemplary embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present disclosure, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A task tracking method, comprising:
recognizing, through a message communication tool, and tracking, as a task, a message, wherein the message further comprises project information associated with a project or complete date information of the task associated with the project;
identifying a member and a non-member of the task in response to tracking the task; and
assigning the task associated with the project to the non-member through the message communication tool and granting a right to use the task so that collaboration is performed between the member and the non-member.

2. The task tracking method of claim 1, wherein the assigning and the granting further comprising:
granting the non-member a right to use a specific task associated with the project in response to a preset tag being assigned to a name of the non-member.

3. The task tracking method of claim 2, wherein the assigning and the granting further comprising:
displaying the specific task assigned to the non-member through the message communication tool.

4. The task tracking method of claim 1, wherein the assigning and the granting further comprising:
transferring, by email of a user, the project or the task associated with the project to the user when the user is not using the message communication tool.

5. The task tracking method of claim 4, wherein the assigning and the granting further comprising:
indicating that a reply is to be automatically added as a comment to a main text of the project or the task associated with the project, wherein the reply is made by the user that does not use the message communication tool in response to the user receiving the project or the task associated with the project that is transferred to the user by e-mail.

6. The task tracking method of claim 1, wherein the assigning and the granting further comprising:
providing an interface of managing a mail using the task, and moving the mail to the task in response to an instruction input through the interface.

7. The task tracking method of claim 6, wherein the assigning and the granting further comprising:
displaying a message indicating that the mail is moved to the project or the task associated with the project in response to the mail being moved to the task.

8. A non-transitory computer-readable medium having stored thereon computer-executable instructions configured to cause a processor to perform operations comprising:
recognizing, through a message communication tool, and tracking, as a task, a message, wherein the message further comprises project information associated with a project or complete date information of a task associated with the project;
identifying a member and a non-member of the task in response to tracking the task; and
assigning the task associated with the project to the non-member through the message communication tool and granting a right to use the task so that collaboration is performed between the member and the non-member.

9. A task tracking system, comprising
a processor configured with processor-executable instructions to:
recognize, through a message communication tool, and track, as a task, a message, wherein the message further comprises project information associated with a project or complete date information of a task associated with the project;
identify a member and a non-member of the task in response to tracking the task; and
assign the task associated with the project to the non-member through the message communication tool and grant a right to use the task so that collaboration is performed between the member and the non-member.

10. The task tracking system of claim 9, wherein the processor is further configured with processor-executable instructions to grant the non-member a right to use a specific task associated with the project in response to a preset tag being assigned to a name of the non-member.

11. The task tracking system of claim 10, wherein the processor is further configured with processor-executable instructions to display the specific task assigned to the non-member through the message communication tool.

12. The task tracking system of claim 9, wherein the processor is further configured with processor-executable instructions to transfer, by email of a user, the project or the task associated with the project to the user when the user is not using the message communication tool.

13. The task tracking system of claim 12, wherein the processor is further configured with processor-executable instructions to indicate that a reply is to be automatically added as a comment to a main text of the project or the task associated with the project, wherein the reply is made by the user that does not use the message communication tool in response to the user receiving the project or the task associated with the project that is transferred to the user by e-mail.

14. The task tracking system of claim 9, wherein the processor is further configured with processor-executable instructions to provide an interface of managing a mail using the task, and moving the mail to the task in response to an instruction input through the interface.

15. The task tracking system of claim 14, wherein the processor is further configured with processor-executable instructions to display a message indicating that the mail is moved to the project or the task associated with the project in response to the mail being moved to the task.
